(19) United States
(12) Patent Application Publication
(10) Pub. No.: US 2026/0261868 A1
(43) Pub. Date: Sep. 3, 2026

(54) SYSTEM AND METHOD FOR PROVIDING A NOMINAL SITE LOCATION GENERATION STRATEGY

(71) Applicant: JIO PLATFORMS LIMITED, Ahmedabad (IN)

(72) Inventors: Haresh B. AMBALIYA, Amreli (IN); Sundaresh SANKARAN, West Mumbai (IN); Vikram SINGH, Mumbai (IN); Makarand DERE, Panvel (IN); Aayush BHATNAGAR, Navi Mumbai (IN); Madhulika Arvind TIPLE, Navi Mumbai (IN); Pradeep Kumar BHATNAGAR, Navi Mumbai (IN)

(73) Assignee: JIO PLATFORMS LIMITED, Ahmedabad (IN)

(21) Appl. No.: 18/881,649

(22) PCT Filed: Jan. 30, 2024
(86) PCT No.: PCT/IB2024/050838

§ 371 Date: Jan. 6, 2025

(30) Foreign Application Priority Data
Jan. 31, 2023 (IN) 202321006295

(51) Int. Cl. H04W 16/18

(52) U.S. Cl. CPC H04W 16/18

(57) ABSTRACT

The disclosed system and method provide a nominal site location generation strategy. The disclosed system and method automate a process of nominal site location generation and nominal validation by providing a simple web interface. A user defines input requirements for a geography on the web interface to obtain the nominal site location. Thus, an entire process of ingesting huge crowd sourced data and geospatial data, doing predictions and analysis for getting optimal sites is fully automated.

### RESERVATION OF RIGHTS

A portion of the disclosure of this patent document contains material which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner. TECHNICAL FIELD The present disclosure relates to a field of wireless networks, and specifically to a system and a method for providing a nominal site location generation strategy.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Worldwide there are approximately 4 million cell sites radiating 4G networks, which were deployed while focusing on providing only for mobile broadband service. Fifth generation cellular network promises ranges of services broadly categorized into enhanced mobile broadband (eMBB), Ultra-reliable and Low-Latency communication (uRLLC) and Massive Machine Type Communications (mMTC). As every service type has different design targets so planning and deployment needs to be tailored for a target service. With wide ranges of possible 5G use cases, aimed to connect millions of devices and humans using higher frequency bands, it is a very cumbersome and complex process to run multiple iterations and obtain an optimal site plan and cell configuration designed for a given coverage and capacity criteria.

This is because the task of network planning is done conventionally by hundreds of engineers using desktop based tools, which involve huge man-hours for collecting the data, pre-processing followed by radio predictive tasks to determine best possible locations for new proposed sites and cell level physical problems. So, the traditional approach is manual and tedious as well. Few of the challenges faced while using the conventional approach for network planning are involvement of manual and tedious work, undefined planning processes, challenges in dealing with crowd sourced data, inability of scale, requirement of a steep learning curve, challenges faced in storing and doing spatial queries on geo datasets such as fiber, hotspots, etc.

There is, therefore, a need in the art for an improved system and method that effectively provides a nominal site location generation strategy and provides a good coverage in the generated site location.

### OBJECTS OF THE PRESENT DISCLOSURE

It is an object of the present disclosure to provide a system and a method for providing a nominal site location generation strategy.

It is an object of the present disclosure to streamline site location planning process by automating and stitching all necessary components.

It is an object of the present disclosure to obtain an optimal site/cell list based on inputs used for planning.

It is an object of the present disclosure to provide a robust system for network planning.

### SUMMARY

In an exemplary embodiment, the present invention discloses a method for determining a nominal site location for cellular planning. The method comprising receiving, from one or more data sources, geographic data related to a geographic region of interest. The method comprising obtaining at least one traffic data for the geographic region of interest. The traffic data, in one example, may refer to information about cellular traffic at the geographic region of interest. In one example, the traffic data may include data associated with underlying clutter type, vector data-based data sources such as railways and highways, data associated with vehicular traffic and congestion and the like. The method comprising receiving at least one input for the cellular planning. The at least one input comprising user focused inputs, area-based inputs, cell-focused inputs, point of interest focused inputs and custom input. The method comprising identifying a first nominal location based on the traffic data and at least one input.

The method may include generating one or more nominal locations concurrently or serially or both. In an example, query based nominal location may be generated based on landmark, building, marketing inputs, figure structure/equipment data, demand points, area of local importance, rollout obligations. In another example, highway/railway nominal locations may be identified based on vector data-based data sources associated with highway and/or railway. In other examples, there may be nominal locations identified based on mandatory site requirements and/or rollout obligations. In one implementation, the nominations may be generated in parallel. The method may include obtaining further inputs from user including exclusion zones, and other inputs. The method comprising determining at least one second nominal location based on processing the first nominal location(s), the traffic data and the at least one input.

In some embodiments, the at least one input comprising user focused inputs, area-based inputs, cell-focused inputs, point of interest focused inputs and custom input.

In some embodiments, when the traffic data is a clutter type data, the at least one second nominal location is determined based on underlying clutter in the geographic region of interest and the first nominal location.

In some embodiments, when the traffic data is at least one of the transport infrastructure based data and the traffic based data, the at least one second nominal location is determined based on inter site distance from the first nominal location. The inter site distance is a product of inter site coefficient and cell radius.

In some embodiments, the method further comprises, performing the network planning based on the first nominal location and the at least one second nominal location on an existing network infrastructure or on a new network infrastructure.

In an exemplary embodiment, the present invention discloses a system for providing a nominal site location. The system comprising a receiving unit configured to receive at least one input for the cellular planning, a database configured to store a geographic data related to a geographic region of interest, and a traffic data. The geographic data is received from one or more data sources. The system further comprising a processing unit coupled to the receiving unit and the database and is configured to identify a first nominal location based on the traffic data and the at least one input and determine at least one second nominal location based on processing the first nominal location, the traffic data and the at least one input.

In some embodiments, the at least one traffic data comprising clutter type data, transport infrastructure based data, and traffic based data.

In some embodiments, the at least one input comprising user focused inputs, area-based inputs, cell-focused inputs, point of interest focused inputs and custom input.

In some embodiments, the traffic data is a clutter type data, the at least one second nominal location is determined based on underlying clutter in the geographic region of interest and the first nominal location.

In some embodiments, when the traffic data is at least one of the transport infrastructure based data and the traffic based data, the at least one second nominal location is determined based on inter site distance from the first nominal location. The inter site distance is a product of inter site coefficient and cell radius.

In some embodiments, the system is further configured to perform the network planning based on the first nominal location and the at least one second nominal location on an existing network infrastructure or on a new network infrastructure.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates a high-level flow of input metrics elements supported by a NG_Strategy module, in accordance with an embodiment of the present disclosure.

FIG. 2 illustrates an exemplary NG_Strategy sub process, in accordance with an embodiment of the present disclosure.

FIG. 3 illustrates an exemplary mechanism for triggering NG_Strategy job, in accordance with an embodiment of the present disclosure.

FIG. 4 illustrates a series of steps for a strategic nominal planning mechanism, in accordance with an embodiment of the present disclosure.

FIG. 5 illustrates a query based nominal generation mechanism, in accordance with an embodiment of the present disclosure.

FIG. 6 illustrates a highway nominal generation mechanism, in accordance with an embodiment of the present disclosure.

FIG. 7 illustrates an obligation based nominal generation mechanism, in accordance with an embodiment of the present disclosure.

FIG. 8 illustrates a series of steps for determination of an exclusion zone, in accordance with an embodiment of the present disclosure.

FIG. 9 illustrates an exemplary component of a network device.

### LIST OF REFERENCE NUMERALS

100—High-level flow diagram of NG_Strategy module
200—NG_Strategy sub process
300—Mechanism for triggering NG_Strategy job
400—Flow diagram
500—Query based nominal generation mechanism
600—A highway nominal generation mechanism
700—An obligation based nominal generation mechanism
800—Flow diagram
900—Exemplary components of a network device.
910—Bus
920—Processing unit
930—Main memory
940—Read only memory (ROM)
950—Storage device
960—Input device
970—Output device
980—Communication interface

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Upcoming 5G networks are going to be the biggest enabler for industry 4.0 providing high bandwidth, ultra-low latency and massive Internet of Things (IoT) deployments. However, this requires an effective and efficient 5G network planning and deployment. Disclosed is a system and method for automation of an End-to-End (E2E) 5G radio planning. The disclosed system and method provide unique sets of web applications for automated 5G planning and deployment. The disclosed system and method are based on a cloud native architecture which eliminates a traditional desktop-based approach with an innovative automated planning using radio Application Programming Interfaces (APIs) hosted on centralized infrastructure, which guarantees an optimal planning output and network insights in a time bound manner for making quick business decisions.

The disclosed system and method implement an entirely new approach for planning and designing 5G networks that may be extended to other technologies, for example, Wi-Fi. Planning of any cellular network requires extensive paperwork and simulation tasks before arriving at any final list of sites. The disclosed system and method perform cellular planning which covers all requirements from network capacity/strategic point of view. Further, all site location/cell configurations are auto fine-tuned using a radio predictive engine.

Objective of a Nominal Generation (NG) strategy based planning is to identify a feasible 5G site location based on strategic inputs such as key landmarks, major intersections within city, fiber connected users per building, key railways and roadway connectivity points, key junction of road traffic movement along with marketing inputs and details of nearby fiber routes and fiber networks.

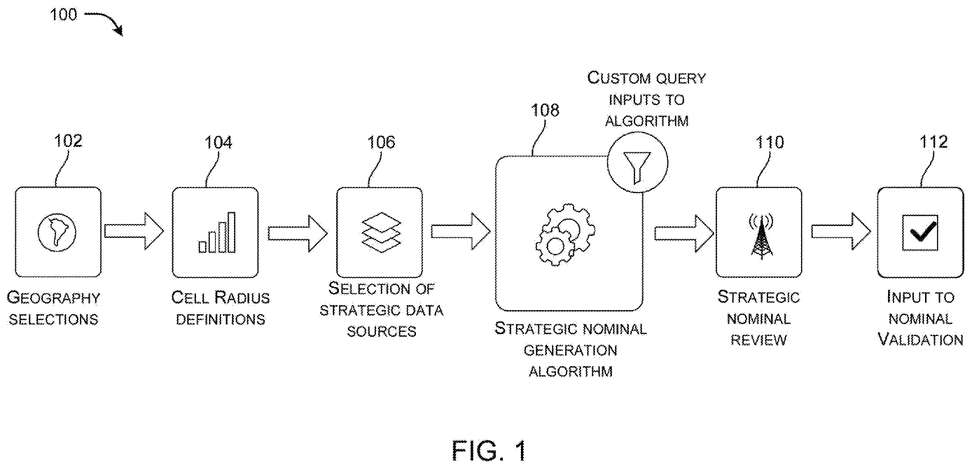

FIG. 1 illustrates a high-level flow 100 of NG_Strategy module, in accordance with an embodiment of the present disclosure. As illustrated, elements are selected based on geography and on a cell radius. Further, a selection of strategic data sources is performed. A strategic nominal generation algorithm is activated on the selected strategic data. Based on custom query inputs to the algorithm, a strategic nominal view is determined. This determined nominal view is sent as an input to nominal validation. The nominals may be site locations and cell configurations.

In an aspect, the present invention discloses a method for determining a nominal site location for cellular planning. The method is implemented in a tool provided in a network device having a web interface.

At step 102, a geographical region of interest where the cellular planning is to be performed is selected. A geographical data that is related to a geographical region of interest is received from a plurality of data sources. In an aspect, the plurality of data sources includes information related to various landmarks, buildings, fiber structure/equipment, demand points, and area of local importance. In an aspect, the plurality of data sources also includes information related to highways, railways, mandatory sites, and rollout obligations. The rollout obligations may refer to the commitments and responsibilities imposed on telecommunication service providers by regulatory authorities or as part of licensing agreements. These obligations are designed to ensure the timely and efficient deployment of telecommunication infrastructure and services, promoting broader coverage, improved quality, and fair competition. The rollout obligations are applicable to various towns and villages present in the geographical area of interest. The plurality of data sources also includes information related to traffic data. The traffic data comprises clutter type data, transport infrastructure based data, and traffic based data. The present invention enables a user to provide at least one input for the cellular planning.

At step 104, the at least one input comprises user focused inputs, area-based inputs, cell-focused inputs, point of interest focused inputs and custom inputs. In an aspect, the at least one input comprises at least one cell parameter (e.g., cell radius).

At step 106, a plurality of strategic data sources are selected. In an aspect, the present invention works on at least on geographical boundary, defined area, polygon-based input with clutter type data. In an aspect, the present invention works on any vector data-based data sources such as railways and highways. In an aspect, the present invention works on vehicular traffic and congestion data.

The present invention enables identifying a first nominal location based on the information provided from a plurality of data sources and at least one input.

At step 108, a plurality of nominal locations is determined based on processing of the first nominal location and the information provided from a plurality of data sources and at least one input with the strategic nominal generation algorithm.

At step 110, the strategic nominal views are generated for review.

At step 112, the nominals identified based on strategic inputs are provided as input to auto nominal validation and further deployment workflow. Thus, the present invention determines a strategic nominal view that can be sent as an input to nominal validation.

In some embodiments, the present invention generates a nominal location when the input information is related to boundary, area, polygon-based input with clutter type and other data sets as inputs. The nominal location is generated for uniform coverage across selected boundary, area, and polygons. An underlying clutter type within a town boundary is identified and a hexagon is identified/drawn for each clutter type based on at least one cell input parameter (e.g., cell radius). A top north corner is identified and at least one underlying clutter type is checked. The hexagon is placed based on the at least one underlying clutter type and priority of clutter and other network technical and not technical parameters as inputs. The surrounding hexagon are placed such that each hexagon having common edge with near next hexagon. At least one hexagon (e.g., dense urban, urban, sub urban, and rural) is selected based on a center point location of the at least one underlying clutter type.

In some embodiments, the present invention generates a nominal location based on a plurality vector data-based data sources such as railways and highways etc. The data/information from a respective data source with a selected geographical data of interest is loaded on the tool. A top north point of respective data source is selected, and any first point is selected as first nominal. At least one cell parameter (e.g., cell radius) of a rural/highway is selected as an input from an input section of a web interface of the tool. An inter site distance is calculated as inter site distance=1.5 (inter site coefficient)×cell radius. A nominal location is selected based on inter site distance from each last selected nominal location. The last location is selected as a nominal location when it is determined that the last point (e.g., including junction where multiple rail/roads cross) of rail or road is within inter site distance and beyond the cell radius distance. A last nominal point of any other route is selected as a reference point to plan nominal on route when it is determined that a rail or road has junction where more than one routes get connected and last nominal is not at junction point. The above algorithm is repeated to cover all rail/road routes in the geographical area of interest.

In some embodiments, the present invention generates a nominal location based on vehicular traffic and congestion-based information. The data/information is loaded from respective data source within a selected geographical data of interest. A traffic colour (e.g., brown & red) is identified for minimum 7 (traffic days)/7 days for minimum X (traffic hours)/24 hours. Here, X is configurable. A top north point of respective traffic congested path is selected. A first point is selected as first nominal. It is checked whether any existing nominal is planned within inter site distance to cover last congested routes. When a nominal is found with inter site distance then site is planned at end of inter site distance. At least one cell parameter (e.g., cell radius) of a rural/highway is selected as an input from an input section of a web interface of the tool. An inter site distance is calculated as inter site distance=1.5 (inter site coefficient)×cell radius. A nominal location is selected based on inter site distance from each last selected nominal location. The last location is selected as a nominal point when a last point (e.g., junction where multiple congested routes cross) of the congested route is with inter site distance and beyond the cell radius distance. If than consider other route last nominal point as a reference point to plan nominal on route. Any other route's last nominal point is selected as a reference point to plan nominal on route when it is determined that congested route has junction where more than one routes get connected and last nominal is not at junction point. The above algorithm is repeated to cover all congested routes in the geographical area of interest.

In an aspect, the present invention performs a network planning based on the nominal locations on an existing network infrastructure or on a new network infrastructure. The present disclosure supports both greenfield and brownfield mode. The existing network infrastructure are the brownfield sites that are located in urban areas because they've previously been built upon. On the other hand, the new network infrastructure are the greenfield sites that have never been built on and is being created.

In an aspect, the present invention can be implemented in a system comprising a receiving unit, a database and a processing unit for the cellular planning. The system may comprise a tool that comprises a web interface where a plurality of inputs can be entered for the determining nominal locations.

Thus, the present invention streamlines the cellular planning process by automating & stitching all the components and providing an optimal site/cell list.

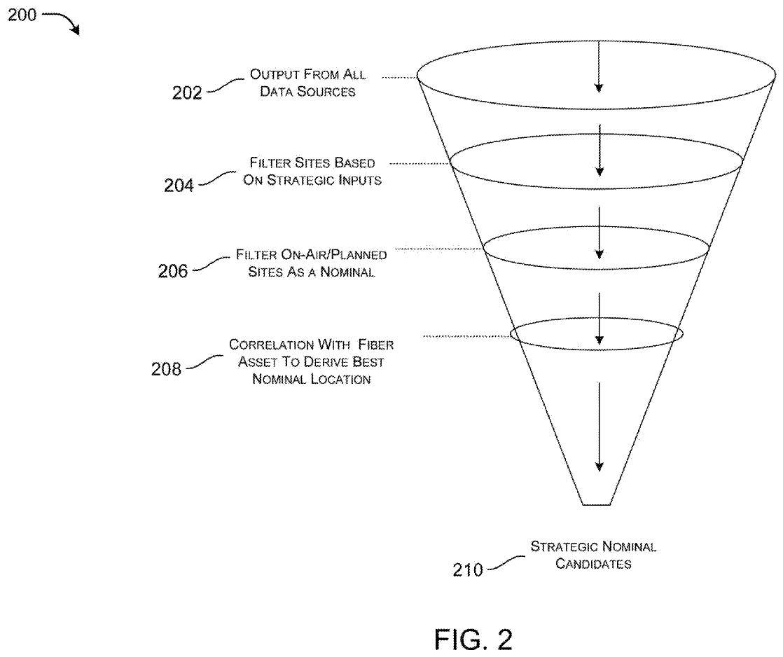

FIG. 2 illustrates an exemplary NG_Strategy sub process 200, in accordance with an embodiment of the present disclosure.

As is illustrated, at step 202, the process includes receiving an output from all data sources which may be stored in the database.

Further, at step 204, sites are filtered based on strategic inputs.

At step 206, the processing unit filters on-air/planned sites as a nominal.

At step 208, the process includes determining correlation with fiber assets to derive the best nominal location.

At step 210, strategic nominal candidates are obtained.

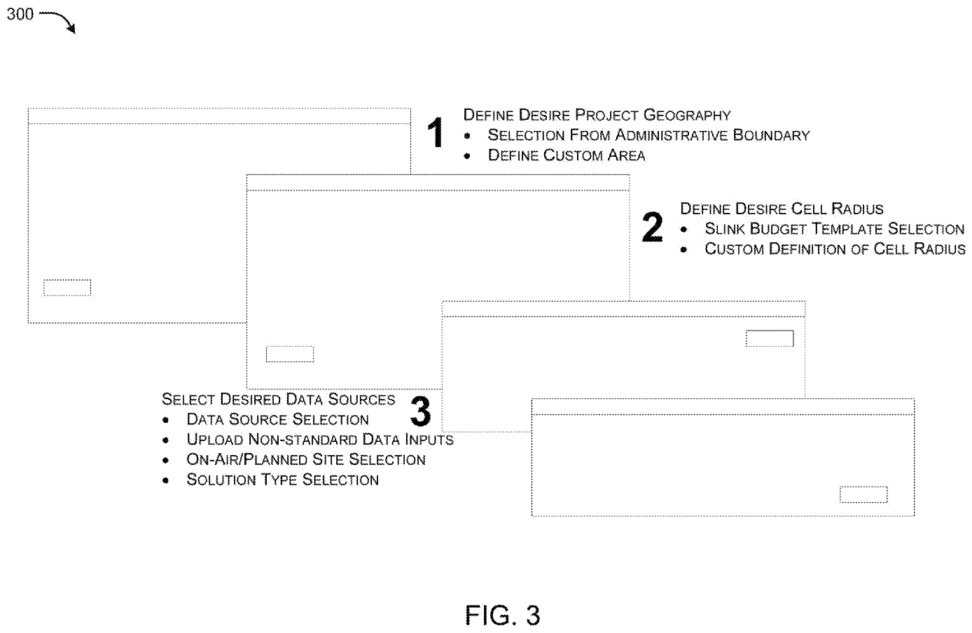

FIG. 3 illustrates an exemplary mechanism 300 for triggering NG_Strategy job, in accordance with an embodiment of the present disclosure. As illustrated, at step 1, a desired project geography is defined based on input received by the receiving unit. This involves selection from administrative boundary and defining of custom areas. At step 2, desired cell radius is defined based on input received by the receiving unit. This includes linking of budget template selection and custom definition of cell radius. At step 3, desired data sources are selected. This includes data source selection, uploading of non-standard data inputs, selection of desired query, on-air/planned site selection, and solution type selection.

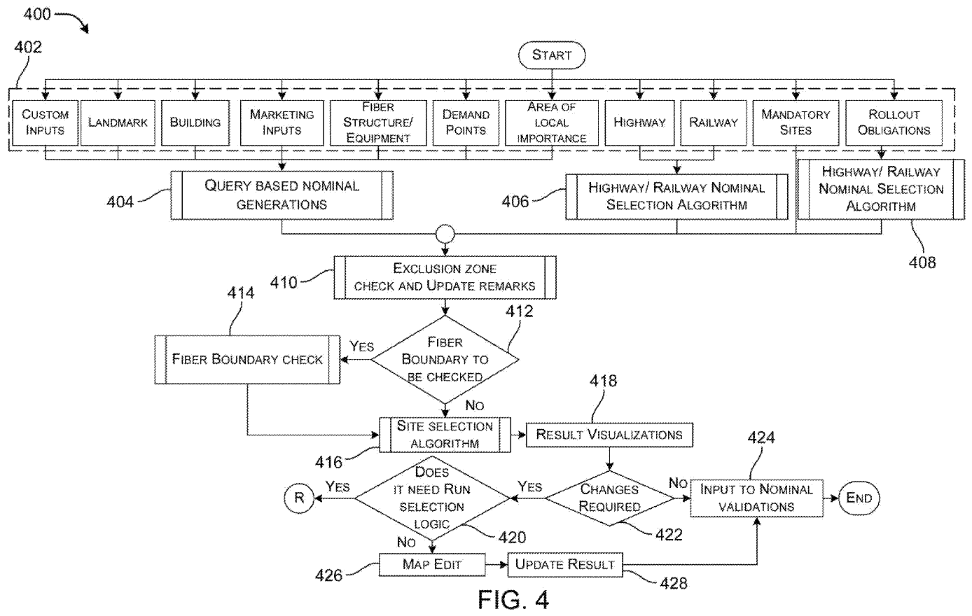

FIG. 4 illustrates a series of steps for a strategic nominal planning mechanism 400, in accordance with an embodiment of the present disclosure.

At step 402, a plurality of inputs such as custom inputs, information about landmarks, buildings, marketing inputs, fiber structure/equipment, demand points, area of local importance, highway, railway, mandatory sites and rollout obligations are received.

As is illustrated, at step 404, query based nominal generators receive custom inputs, information about landmarks, buildings, etc. Further, marketing inputs, fiber structure/equipment, demand points, and area of local importance is received. Highway/railway nominal selection algorithm receives inputs through the receiving unit from highway and railway. Input is also received from mandatory sites the receiving unit. Next obligation based selection logic receives input from rollout obligations.

At step 406 and 408, input from the query based nominal generators, the highway/railway nominal selection algorithm, and the obligation based selection logic are collated by the processing unit.

Further, at step 410, the exclusion zone is checked, and remarks are updated. At step 412, it is determined whether a fiber boundary is to be checked. At step 414, if the determination is affirmative, then the fiber boundary is checked, and at step 416, if the determination is not affirmative, then a site selection algorithm is used to generate result visualizations at step 418. Further, at step 422 and 420, if changes are required in the result visualizations, then it is determined whether it needs a run selection logic respectively. At step 424, if changes are not required, then input is provided to nominal variations. At step 426, if the run selection logic is not required, then a map edit is performed, result is updated at step 428, and input is provided to nominal variations.

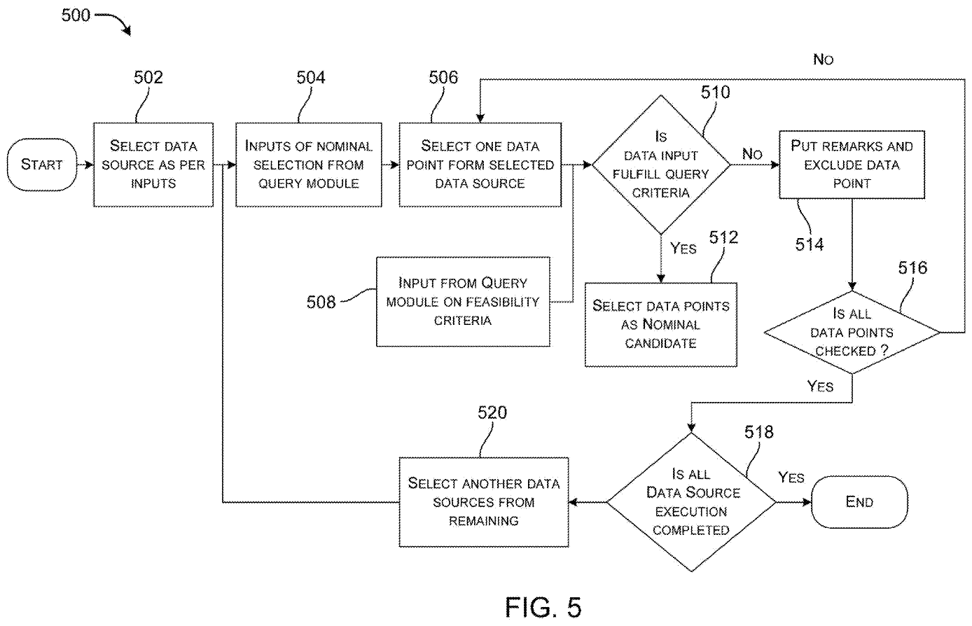

FIG. 5 illustrates a query based nominal generation mechanism 500, in accordance with an embodiment of the present disclosure. As is illustrated, at step 502, a data source is selected as per inputs. Further, at step 504, inputs of nominal selection from the query module are determined. Next, at step 506, one data point is selected from a selected data source. In addition, at step 508, an input from a query module on feasibility criteria is determined. At step 510, these are used to determine whether data input fulfils query criteria. at step 512, if the data input fulfils the query criteria, data points are selected as a nominal candidate. At step 514, if the data input does not fulfil the query criteria, then remarks are inserted, and data point is excluded. Next, at step 516, it is determined if all the data points are checked. If yes, then at step 518, it is determined whether data source execution is completed. If the data source execution is not completed, then at step 520, other data sources from remaining inputs are selected.

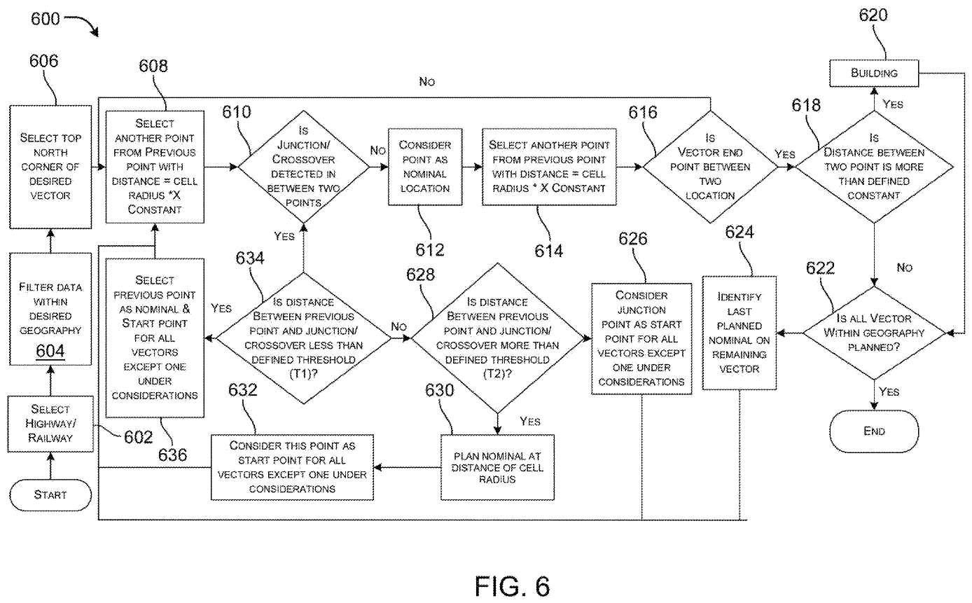

FIG. 6 illustrates a highway nominal generation mechanism 600, in accordance with an embodiment of the present disclosure. As is illustrated, at step 602, a highway/railway is selected. at step 604, data within desired geography is filtered. Next, at step 606, a top north corner of a desired vector is selected. Further, at step 608, another point from previous point with distance “cell radius” X constant is selected. At step 610, it is determined if a junction/crossover is detected in between two points. If not, then at step 612, the point is considered as a nominal function and at step 614, another point from the previous point with distance “cell radius” X constant is selected. Further, at step 616, it is determined if there is a vector end point between two locations. If yes, at step 618, it is determined if distance between two points is more than defined constant. If the distance is more than the defined constant, then at step 620, the point is considered as normal (e.g., a building), else at step 622, it is determined if all vectors within geography are planned. This results in identifying a last planned nominal on a remaining vector at step 624.

If the junction/crossover is detected in between two points, then it is determined whether distance between previous point and junction/crossover is less than a defined threshold at step 634. If the distance is less, then the previous point is selected as nominal, and a start point for all vectors except one is kept under consideration at step 636. Further, if the distance between the previous point and the junction/crossover is not less than defined threshold, then it is determined whether distance between the previous point and junction/crossover is more than the defined threshold at step 628. If yes, then at step 630, a nominal is planned at distance of cell radius and at step 632, this point is considered as the start point for all vectors except one under considerations. Further, if it is determined that the distance between the previous point and junction/crossover is not more than the defined threshold, then at step 626, the junction point is considered as the start point for all vectors except one under considerations.

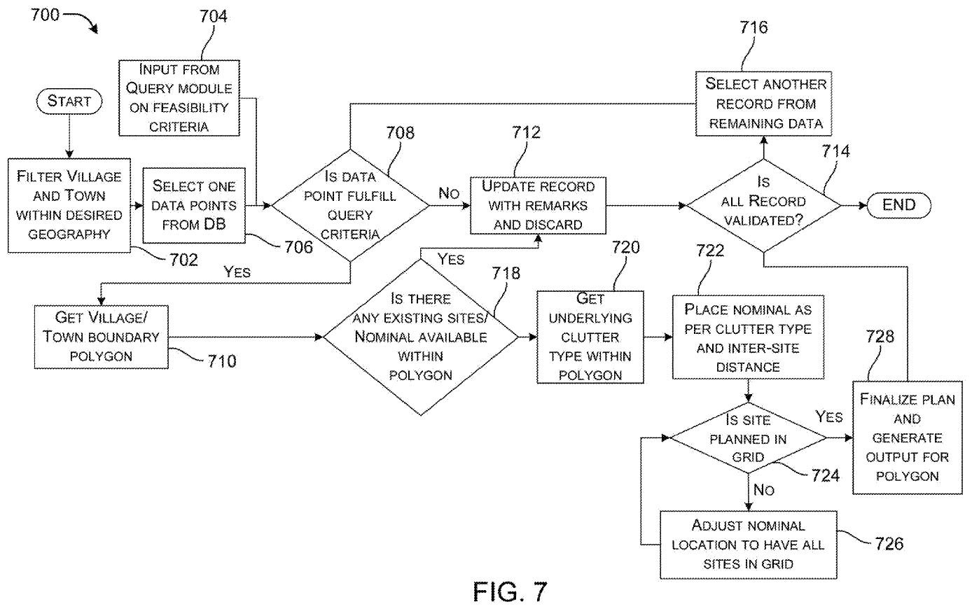

FIG. 7 illustrates an obligation based nominal generation mechanism 700, in accordance with an embodiment of the present disclosure. As is illustrated, at step 702, a village and a town are filtered within a desired geography through the receiving unit. Further, at step 704, an input from a query module on feasibility criteria is received and at step 706, one data point from a database is selected. At step 708, these data are used to determine if a data point fulfils query criteria. At step 710, if the data point fulfils the query criteria, then a village/town boundary polygon is obtained. Next, it is determined by processing unit if there are any existing sites/nominal available within the polygon. If yes, then a record is updated with remarks and discarded at step 712. At step 714, when all records are validated, another record is selected from the remaining data at step 716. However, if it is determined that there are no existing sites/nominal available within the polygon (at step 718), then at step 720, an underlying clutter type is obtained within the polygon. Next, at step 722, a nominal is placed per clutter type and an inter-state distance. Further, at step 724, it is determined if a site is planned in the grid. At step 726, if it is determined that the site is not planned, then a nominal location is adjusted to have all sites in the grid. However, at step 728, if it is determined that the site is planned, then a plan is finalized and an output for polygon is generated.

Also, using the updated record and the finalized plan, it is determined if all the records are validated. When it is determined that all the records are not validated, then another record is selected from remaining data, else the algorithm is terminated.

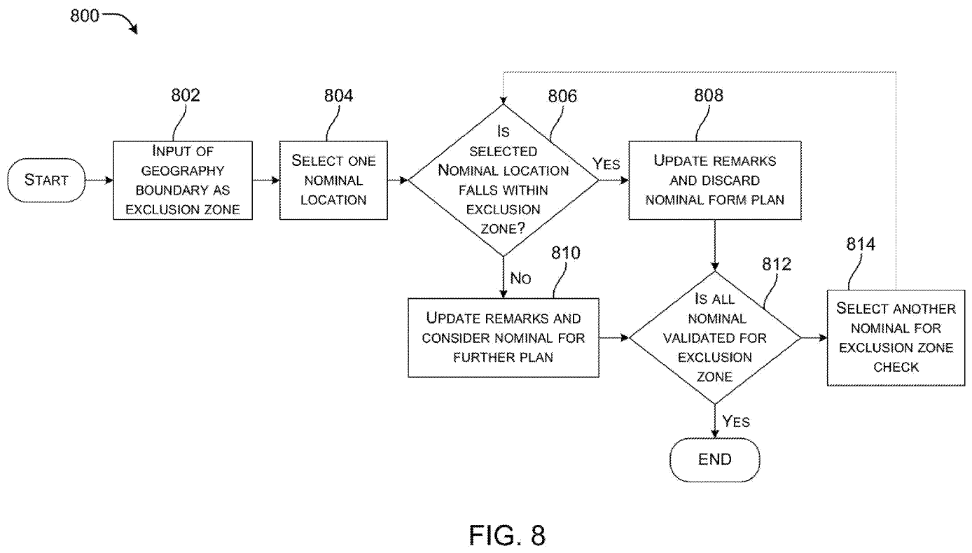

FIG. 8 illustrates a series of steps for determination of an exclusion zone 800, in accordance with an embodiment of the present disclosure. As is illustrated, at step 802, an input of a geography boundary as an exclusion zone is determined. Next, at step 804, one nominal location is selected. Further, at step 806, it is determined if the selected nominal location falls within the exclusion zone. If the nominal location falls within the exclusion zone, then at step 808, remarks are updated, and nominal is discarded from the plan. Else, at step 810, remarks are updated and considered for further plan. Further, at step 812, it is determined if all nominals are validated for the exclusion zone. If all the nominals are not validated, then at step 814, another nominal is selected for an exclusion zone check, else the algorithm is terminated.

Following this, geospatial inputs are used in the component 1. All these are used for identifying the key strategic areas for nominal generation. The geospatial inputs include, for example, railways, highways, marketing inputs, exclusion zones (restricted area), area of local importance-local area knowledge, strategic sites, rollout obligations (town and village), fiber routes, structure and equipment, buildings, landmarks, demand points (FTTX), and custom data (Non-Standard Data).

In an embodiment, there is disclosed a nominal generation algorithm that works on boundary, area, or polygon based input with clutter type and other data sets as inputs. Nominal may be generated for uniform coverage across selected boundary/area/polygons. The nominal generation algorithm functions by identifying underlying clutter type within town boundary, for drawing hexagon for each clutter type based on cell radius, identifying top north corner and check underlying clutter and place hexagon based on clutter type and priority of clutter and other network technical and not technical parameters as inputs, placing surrounding hexagon such that each hexagon having common edge with near next hexagon, and selecting hexagon (dense urban, urban, sub urban, rural) based on center point location underlying clutter type.

In an embodiment, the nominal generation algorithm may work on any vector data-based data sources such as railways and highways.

Steps for execution of the nominal generation for any of the vector data-based data sources such as railways and highways are discussed below:
1. Load data from respective data sources within selected geography.
2. Select a top north point of a respective data source.
3. Select a first point as a first nominal based on point 2.
4. Use rural/highway cell radius from an input section as an input.
5. Use inter site distance=1.5 (Inter site coefficient)×Cell Radius
6. Start selection nominal based on inter site distance from each last selected nominal location.
7. If a last point (which includes a junction where multiple rail/roads cross) of rail/road is within inter-site distance and beyond cell radius distance, select last location as a nominal point.
8. If a rail/road has a junction where more than one route gets connected, and the last nominal is not at a junction point, then consider another route's last nominal point as a reference point to plan nominal on route.
9. Repeat above steps till all the rail/road routes gets covered.

In an embodiment, there is disclosed a nominal generation algorithm that works on vehicular traffic and congestion based on information. Steps for execution of the nominal generation for vehicular traffic and congestion are discussed below:
1. Load data from respective data sources within a selected geography.
2. Identify traffic colour (Brown &amp; Red) for minimum 7 (Traffic Days)/7 days for minimum X (Traffic Hours)/24 hours. (X may be configurable).
3. Select a top north point of a respective traffic congested path.
4. Select first point as first nominal based on point 2 or check for any existing nominal planned within inter site distance to cover last congested routes, if nominal found with inter site distance than plan site at end of inter site distance.
5. Use Rural/Highway cell radius from an input section as an input.
6. Use inter site distance=1.5 (Inter site coefficient)×Cell Radius
7. Start selection nominal based on inter site distance from each last selected nominal location.
8. If the last point (which includes a junction where multiple congested routes cross) of congested route is within an inter site distance and beyond cell radius distance, select last location as a nominal point.
9. If a congested route has a junction where more than one route gets connected, and the last nominal is not at the junction point then consider another route's last nominal point as a reference point to plan nominal on route.
10. Repeat above steps till all congested routes get covered.

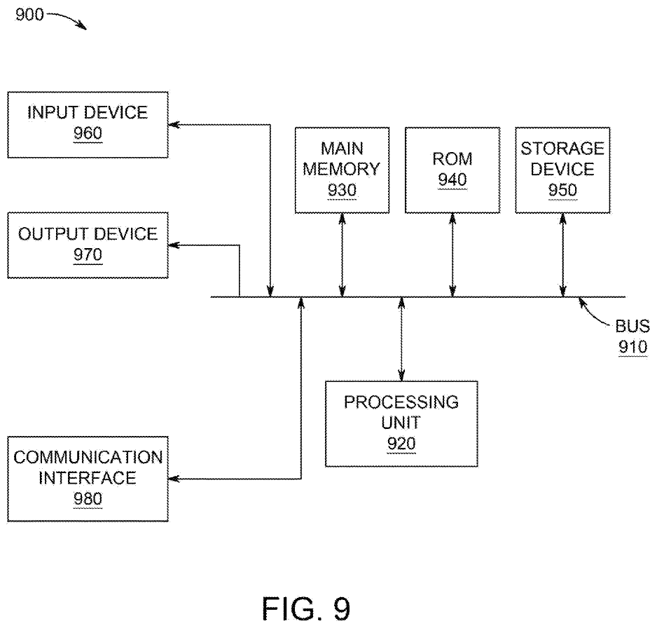

FIG. 9 is a diagram that depicts exemplary components of a network device 900. The NG_Strategy module, the data sources and the user devices may each include components the same as, or similar to, the network device 900 shown in FIG. 9, arranged in a same, or similar, configuration, as that shown in FIG. 9. Network device 900 may include a bus 910, a processing unit 920, a main memory 930, a read only memory (ROM) 940, a storage device 950, an input device 960, an output device 970, and a communication interface 980. Bus 910 may include a path that permits communication among the other components of network device 900. Processing unit 920 may include one or more processors or microprocessors which may interpret and execute stored instructions associated with one or more processes, or processing logic that implements the one or more processes. For example, processing unit 920 may include, but is not limited to, programmable logic such as Field Programmable Gate Arrays (FPGAs) or accelerators. Processing unit 920 may include software, hardware, or a combination of software and hardware for executing the processes described herein. Main memory 930 may include a random-access memory (RAM) or another type of dynamic storage device that may store information and, in some implementations, instructions for execution by processing unit 920. ROM 940 may include a ROM device or another type of static storage device (e.g., Electrically Erasable Programmable ROM (EEPROM)) that may store static information and, in some implementations, instructions for use by processing unit 920. Storage device 950 may include a magnetic, optical, and/or solid state (e.g., flash drive) recording medium and its corresponding drive. Main memory 930, ROM 940 and storage device 950 may each be referred to herein as a “non-transitory computer-readable medium” or a “non-transitory storage medium.”The process/methods set forth herein can be implemented as instructions that are stored in main memory 930, ROM 940 and/or storage device 950 for execution by processing unit 920.

Input device 960 may include one or more devices that permit an operator to input information to network device 900, such as, for example, a keypad or a keyboard, a display with a touch sensitive panel, voice recognition and/or biometric mechanisms, etc. Output device 970 may include one or more devices that output information to the operator, including a display, a speaker, etc. Input device 960 and output device 970 may, in some implementations, be implemented as a user interface (UI) that displays UI information and which receives user input via the UI. Communication interface 980 may include one or more transceivers that enable network device 900 to communicate with other devices and/or systems. For example, communication interface 980 may include one or more wired or wireless transceivers for communicating via network 930.

Network device 900 may perform certain operations or processes, as may be described herein. Network device 900 may perform these operations in response to processing unit 920 executing software instructions contained in a computer-readable medium, such as memory 930. A computer-readable medium may be defined as a physical or logical memory device. A logical memory device may include memory space within a single physical memory device or spread across multiple physical memory devices. The software instructions may be read into main memory 930 from another computer-readable medium, such as storage device 950, or from another device via communication interface 980. The software instructions contained in main memory 930 may cause processing unit 920 to perform the operations or processes, as described herein. Alternatively, hardwired circuitry (e.g., logic hardware) may be used in place of, or in combination with, software instructions to implement the operations or processes, as described herein. Thus, exemplary implementations are not limited to any specific combination of hardware circuitry and software.

The configuration of components of network device 900 illustrated in FIG. 9 is for illustrative purposes only. Other configurations may be implemented. Therefore, network device 900 may include additional, fewer and/or different components, arranged in a different configuration, than depicted in FIG. 9

In an aspect, the disclosed system and method automates a process of nominal site generation and nominal validation by providing a simple web interface, where the user can define the input requirement for a geography. Thus, an entire process of ingesting huge crowd sourced data, geospatial data and doing predictions and analysis for getting the optimal sites is fully automated.

In an aspect, the present disclosure can be implemented within network elements that may involve various algorithms, protocols, or mechanisms for nominal site generation for 5G network.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

### Advantages of the Present Disclosure

The present disclosure supports providing a nominal site location generation strategy.

The present disclosure streamlines a site location planning process by automating and stitching all necessary components.

The present disclosure obtains an optimal site/cell list based on inputs used for planning.

The present disclosure provides strategies which are either user focused, cell focused, area focused, or building/Point of Interest (POI) focused.

The present disclosure supports both greenfield and brownfield mode.

The present disclosure provides rich geospatial data sets integration such as fiber boundary, rail, roads, building, key landmark areas, town, and village boundary, etc.

We claim:

1. A method for determining a nominal site location for cellular planning, the method comprising:
receiving, from one or more data sources, geographic data related to a geographic region of interest;
obtaining traffic data for the geographic region of interest;
receiving at least one input for the cellular planning;
identifying a first nominal location based on the traffic data and at least one input; and
determining at least one second nominal location based on processing the first nominal location, the traffic data and the at least one input.

2. The method as claimed in claim 1, wherein the traffic data comprises clutter type data, transport infrastructure based data, and traffic based data.

3. The method as claimed in claim 1, wherein the at least one input comprising user focused inputs, area-based inputs, cell-focused inputs, point of interest focused inputs and custom input.

4. The method as claimed in claim 2, wherein when the traffic data is the clutter type data, the at least one second nominal location is determined based on underlying clutter in the geographic region of interest and the first nominal location.

5. The method as claimed in claim 2, wherein when the traffic data is at least one of the transport infrastructure based data and the traffic based data, the at least one second nominal location is determined based on inter site distance from the first nominal location, wherein the inter site distance is a product of inter site coefficient and cell radius.

6. The method as claimed in claim 1 further comprising, performing a network planning based on the first nominal location and the at least one second nominal location on an existing network infrastructure or on a new network infrastructure.

7. A system for determining a nominal site location for cellular planning, the system comprising:
a receiving unit configured to receive at least one input for the cellular planning;
a database configured to store a geographic data related to a geographic region of interest, and a traffic data; wherein the geographic data is received from one or more data sources;
a processing unit coupled to the receiving unit and the database and is configured to:
identify a first nominal location based on the traffic data and the at least one input; and
determine at least one second nominal location based on processing the first nominal location, the traffic data and the at least one input.

8. The system as claimed in claim 7, wherein the traffic data comprising clutter type data, transport infrastructure based data, and traffic based data.

9. The system as claimed in claim 7, wherein the at least one input comprising user focused inputs, area-based inputs, cell-focused inputs, point of interest focused inputs and custom input.

10. The system as claimed in claim 8, wherein when the traffic data is the clutter type data, the at least one second nominal location is determined based on underlying clutter in the geographic region of interest and the first nominal location. underlying clutter in the geographic region of interest and the first nominal location.

11. The system as claimed in claim 8, wherein when the traffic data is at least one of the transport infrastructure based data and the traffic based data, the at least one second nominal location is determined based on inter site distance from the first nominal location, wherein the inter site distance is a product of inter site coefficient and cell radius.

12. The system as claimed in claim 7, wherein the system is further configured to perform a network planning based on the first nominal location and the at least one second nominal location on an existing network infrastructure or on a new network infrastructure.

13. A computer program product comprising a non-transitory computer-readable medium comprising instructions that, when executed by one or more processors, cause the one or more processors to perform a method for determining a nominal site location for cellular planning, the method comprising:
receiving, from one or more data sources, geographic data related to a geographic region of interest;
obtaining at least one cellular data for the geographic region of interest;
receiving at least one input for the cellular planning;
identifying a first nominal location based on the cellular data and at least one input; and
determining at least one second nominal location based on processing the first nominal location, the cellular data and the at least one input.
